(19) United States
(12) Patent Application Publication
(10) Pub. No.: US 2008/0125516 A1
(43) Pub. Date: May 29, 2008

(54) Dispersible long-acting mold-proof polyurethanes or urethane adducts and mold-proof materials made thereof

(75) Inventors: Han-Yin Liou, Taoyuan County (TW); Chih-Kai Chiu, Taipei County (TW); Chien-Ming Chen, Hsinchu County (TW)

Correspondence Address: BIRCH STEWART KOLASCH & BIRCH, PO BOX 747, FALLS CHURCH, VA, 22040-0747, US

(73) Assignee: HEADWAY ADVANCED MATERIALS INC.

(21) Appl. No.: 11/604,798

(22) Filed: Nov. 28, 2006

(51) Int. Cl. C08K 5/3447

(52) U.S. Cl. 523/122

(57) ABSTRACT

The present invention discloses a soluble or dispersible long-acting mold-proof polyisocyanate or modified polyurethane, and the mold-proof materials made thereof, wherein an amino group (NH)-containing mold-proof agent (benzimidazol or a derivative thereof) becomes a portion of a PU structure in a urethane or urea reaction; thus, the mold-proof material has the superior compatibility and solubility and can be solved or dispersed in various solvents. Further, the polyisocyanate reacts with a saline and a polyol both having reactive functional groups to implement the adhesion between the mold-proof material and the substrate; thus, the mold-proof material can be applied to an inorganic material, such as a metal or a glass. Therefore, the mold-proof material and the derivatives thereof of the present invention have a superior dispersibility/solubility and a long-acting mold-proof effect.

### FIELD OF THE INVENTION

The present invention relates to a long-acting mold-proof material, wherein the effective period of a mold-proof agent (benzimidazol or a derivative thereof) is prolonged by the chemical bonding and also by its improved solubility in solvents or water. In a urethane or urea synthesis, a mold-proof agent with reactive amino groups is integrated into the structure of a polyisocyanate by the reaction with its isocyanate to form a polyurethane (PU) prepolymer; then, a functional silane and/or a polyol is added to react with the other isocyanates of the PU prepolymer. The formed urethane adduct carrying the mold-proof agent is characterized by the long-acting mold-proof function and the superior solubility.

### BACKGROUND OF THE INVENTION

Mold-proof agents are extensively used in daily living. Among them, benzimidazol, a widely used and low-toxic crystalline powder is frequently used as an antiseptic or mold-proof agent.

Benzimidazol is able to inhibit the synthesis of tubulin by the mechanism interfering with the mitosis of cells. Owing to the very high crystallinity of benzimidazol, its poor solubility in water and solvents makes it inconvenient to use; thus, much of additives is added to disperse benzimidazol. The poor solubility in water and solvents caused the low and insufficient concentration of benzimidazol will decrease the mold-proof effect and the durability. Therefore, excess of agents should be added or newly added to keep the mold-proof or the anti-fungal or mold-proof effect.

### SUMMARY OF THE INVENTION

The primary objective of the present invention is to provide a soluble or dispersible long-acting mold-proof polyisocyanate prepolymer or urethane adducts, wherein the urethane and/or urea reaction is used to combine a mold-proof agent (benzimidazol with amino groups or a derivative thereof), or a silane and/or a polyol (having reactive amino or hydroxyl group to participate in the urea or urethane reaction to form a novel soluble or dispersible long-acting mold-proof material. Thereby, the present invention can overcome the disadvantages of common benzimidazol or the derivatives thereof, for instance, inferior dispersibility, short effective period, and low solubility. Furthermore, the present invention can achieve not only long-acting, but also safe and environment-friendly mold-proof materials and the derivatives thereof.

### DETAILED DESCRIPTION OF THE PREFERRED EMBODIMENTS

The technical contents of the present invention are to be described in detail in cooperation with the drawings below.

In the present invention, a mold-proof agent, an isocyanate (such as diisocyanate, triisocyanate, polyisocyanate, or the like), a silane and a polyol are combined in urethane and/or urea reactions to form a mold-proof PU resin material or the derivatives thereof, wherein the mold-proof agent is benzimidazol containing amino groups NH or a derivative thereof. Amino groups (—NH) of the mold-proof agent can react with the isocyanate group (—NCO) of the polyisocyanate to form a PU prepolymer. Then, the prepolymer reacts with a polyol and a silane to form a long-acting mold-proof urethane adduct or PU material. The reaction formula of forming the PU prepolymer is

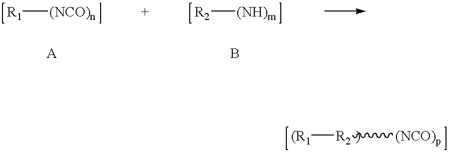

wherein p=n−m>0, and a dispersible urethane adduct is thus formed.

In the abovementioned reaction formula, A is a NCO-containing isocyanate or an adduct thereof which is familiar to the polyurethane artists, and selected from the group consisting of
1. Aliphatic isocyanate, such as 1,6-hexamethylene diisocyanate or isophorone diisocyanate;
2. Aromatic isocyanate, such as 2,4-toluene diisocyanate or Methylene diphenyl diisocyanate; and
3. Polyisocyanate, such as HDI trimer, HDI dimmer, or TDI trimer.

In the abovementioned reaction formula, B is a mold-proof agent of benzimidazol containing amino group NH or a derivative thereof and has the following structural formula:

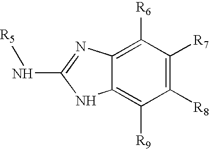

wherein each of the R5˜R9 of the abovementioned structural formula is an atom or a functional group selected from the group consisting of hydrogen, alkyl, alkenyl, alkynyl, acyl, aryl, carboxylate, alkoxycarbonyl, aryloxycarbonyl, carboxamido, alkylamino, acylamino, alkoxyl, acyloxy, hydroxyalkyl, alkoxyalkyl, aminoalkyl, alkylamino, thio, alkylthio, thioalkyl, carbamoyl, urea, thiourea, sulfonyl, sulfonate, sulfonamide, sulfonylamino, and sulfonyloxy.

After the dispersible polyisocyanate ester is formed, a polyol and a silane are added into the polyisocyanate ester to form a mold-proof material, and the reaction formula thereof is

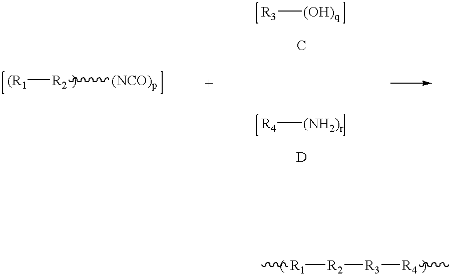

wherein p=q+r.

In the abovementioned reaction formula, C is a polyol selected from the group consisting of
1. a low-molecular weight polyol, such as ethylene glycol, 1,4-butanediol, or trimethylol propane; and
2. a high-molecular weight polyol, such as polyester polyol or polyether polyol.

In the abovementioned reaction formula, D is a silane

H₂N—R₁₀—Si—(R₁₁),

and the amino group (NH2) thereof can be replaced by an atom or a functional group selected from the group consisting of Cl, SH (mercaptide), —CH2=CH2- (allyl-),
methylacrylic ester-,

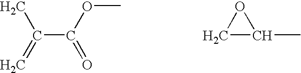

glycidyl,

In the abovementioned silane, R10 is an atom or a functional group selected from the group consisting of alkyl, alkenyl, alkynyl, acyl, aryl, carboxylate, alkoxycarbonyl, aryloxycarbonyl, carboxamido, alkylamino, acylamino, alkoxyl, acyloxy, hydroxyalkyl, alkoxyalkyl, aminoalkyl, alkylamino, thio, alkylthio, thioalkyl, alkylthio, carbamoyl, urea, thiourea, sulfonyl, sulfonate, sulfonamide, sulfonylamino, sulfonyloxy.

In the abovementioned silane, R11 is a hydrogen atom (—H), or an oxidized alkyl group, such as an oxidized methyl —OCH3 or an oxidized ethyl —OC2H5.

An embodiment is to be described with numeric data to exemplify the present invention below.

In one embodiment of the present invention, the fabrication process of the long-acting mold-proof polyisocyanate ester comprises the following steps:
(1) Prepolymer formation: 2.5 moles of MDI (methylene bisphenyl isocyanate), 0.5 moles of a mold-proof agent (methy benzimidazol-2-ylcarbamate), and tin catalyst DBTDL (dibutytin dilaurate) are added into 1280 grams of solvent DMF (dimethyl formamide) to react for 1˜2 hours at 70˜85° C. to form a prepolymer.
(2) Synthesis of a long-acting mold-proof polyisocyanate ester: 1 mole of PEG-2000 (polyethylene glycol with a molecular weight of 2000), 0.5 moles of 1,4-BG (1,4-butanediol) and the prepolymer formed in Step (1) react at 75˜80° C. for 1˜2 hours; next, the temperature is lowered to 40˜45° C., and 1 mole of 3-aminopropylmethyldiethoxysilane containing amino groups —NH2 is added to participate in the reaction, wherein the amino groups react with the —NCO groups until the —NCO group is completely depleted; then, 1707 grams of solvent DMF (dimethyl formamide) is added to adjust the viscosity to about 34000˜37000 cps and the solid ratio to 50%; thus, a long-acting mold-proof polyisocyanate ester is achieved.
(3) Analysis of the mold-proof effect: the long-acting mold-proof material obtained in Step (2) is diluted with a solvent and then daubed on an artificial leather; the mold-proof effect is tested with the test standard for mold-proof products JIS Z 2911:2000, and the bacterium used in the test is Rhizopus (ATCC-6275, American Type Culture Collection); the artificial leather having the mold-proof material daubed on its surface is used as the experimental group, and a common artificial leather without the mold-proof material is used as the control group; the artificial leathers of the experimental group and the control group are respectively cut into circular samples with a diameter of 3 cm; the samples are placed in culture dishes containing a nutrient, and the liquid containing the test bacteria is uniformly sprayed on the samples of the experimental group and the control group; the samples are placed inside a thermo-hydrostat at a temperature of 25° C. and a humidity of 85% for seven days; then, the samples are taken out to observe the growth condition of Rhizopus.

The test results are recorded in the following tables, and the dispersible mold-proof material of the present invention is proved to have the grade 0 mold-proof effect.

| Test Sample | Mold-Proof Grade |
|---|---|
| Control group | Grade 2 |
| (without mold-proof treatment) | |
| Experimental group | Grade 0 |
| (with mold-proof treatment) | |

Test bacterium: Rhizopus (ATCC-6275)
Standard for estimating mold-proof effect
1.Grade 0: none mold: none mold grows on the sample
2.Grade 1: the mycelium area is less than ⅓ of the sample area
3.Grade 2: the mycelium area is over ⅓ of the sample area

### Solubility

| | | Mold-Proof |
|---|---|---|
| | | Material |
| | Unmodified | Modified |
| | Mold-Proof | with a PU |
| | Agent | Reaction |
| Methyl-Ethyl Ketone (MEK) | <0.3% | >50% |
| Dimethylformamide (DMF) | <0.3% | >50% |
| N,N-dimethylacetamide (DMAC) | <0.3% | >50% |
| Methanol (ME) | <0.3% | >50% |
| Ethyl acetate (EAC) | <0.3% | >50% |

In summary, the present invention utilizes a urethane and/or urea reaction to combine an amino group (NH)-containing mold-proof agent, polyisocyanate, silane and polyol to achieve a long-acting mold-proof resin, wherein the molecules of the mold-proof agent integrate with isocyanate and becomes a portion of the polyisocyanate ester structure, and the polyisocyanate ester thus has a mold-proof function. Further, as the mold-proof agent has become a portion of the polyisocyanate ester structure, the present invention can overcome the disadvantages of the conventional mold-proof agent—inferior dispersibility, short effective period, and low solubility and can achieve a novel, safe, environment-friendly long-acting mold-proof material.

Those described above are the preferred embodiments to exemplify the present invention. However, it is not intended to limit the scope of the present invention. Any PU prepolymer and PU hardener fabricated via combining isocyanate/polyisocyanate and a mold-proof agent containing at least one NH group is to be also included within the scope of the present invention, i.e. any equivalent modification and variation according to the spirit of the present invention is to be also included within the scope of the present invention.

1. A dispersible long-acting mold-proof urethane adduct or polyurethane resin, which is fabricated via reacting an amino group (NH)-containing mold-proof agent with an polyisocyanate or its adduct with the reaction formula to form a isocyanate prepolymer or polyurethane prepolymer: wherein p=n−m>0; A 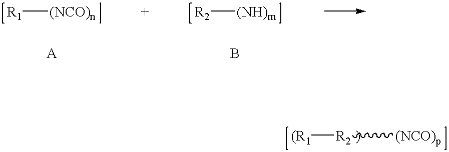
is a NCO-containing isocyanate or a NCO-containing isocyanate polymer; B is an amino group (NH)-containing mold-proof agent.

2. The dispersible long-acting mold-proof urethane adduct or polyurethane resin according to claim 1, wherein said NCO-containing isocyanates or said NCO-containing isocyanate adducts may be selected from the group consisting of aliphatic isocyanate, aromatic isocyanate, and polyisocyanate.

3. The dispersible long-acting mold-proof urethane adduct or polyurethane resin according to claim 1, wherein the structural formula of said amino group (NH)-containing mold-proof agent is 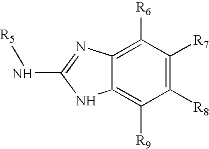
wherein each of the R5˜R9 of said structural formula is an atom or a functional group selected from the group consisting of hydrogen, alkyl, alkenyl, alkynyl, acyl, aryl, carboxylate, alkoxycarbonyl, aryloxycarbonyl, carboxamido, alkylamino, acylamino, alkoxyl, acyloxy, hydroxyalkyl, alkoxyalkyl, aminoalkyl, alkylamino, thio, alkylthio, thioalkyl, carbamoyl, urea, thiourea, sulfonyl, sulfonate, sulfonamide, sulfonylamino, and sulfonyloxy.

4. The dispersible long-acting mold-proof urethane adduct or polyurethane resin according to claim 1, wherein a polyol and a silane are added into said polyisocyanate ester to form a 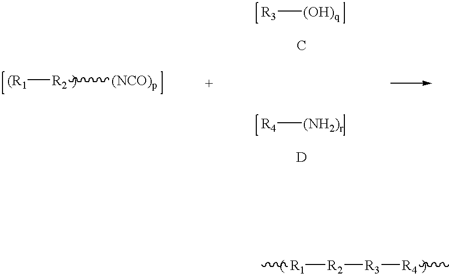
mold-proof material, and the reaction formula thereof is wherein p=q+r.

5. The dispersible long-acting mold-proof urethane adduct or polyurethane resin according to claim 4, wherein said polyol is a low-molecular weight polyol, such as ethylene glycol, 1,4-butanediol, or trimethylol propane.

6. The dispersible long-acting mold-proof polyisocyanate ester according to claim 4, wherein said polyol is a high-molecular weight polyol, such as polyester polyol or polyether polyol.

7. The dispersible long-acting mold-proof polyisocyanate ester according to claim 4, wherein the structural formula of said silane is
H₂N—R₁₀—Si—(R₁₁)
, and the amino group (NH2) thereof can be replaced by a chlorine ion, a sulfate ion, a vinyl group, methyl acrylic acid, or propylene oxide.

8. The dispersible long-acting mold-proof polyisocyanate ester according to claim 7, wherein the R10 of said structural formula is an atom or a functional group selected from the group consisting of alkyl, alkenyl, alkynyl, acyl, aryl, carboxylate, alkoxycarbonyl, aryloxycarbonyl, carboxamido, alkylamino, acylamino, alkoxyl, acyloxy, hydroxyalkyl, alkoxyalkyl, aminoalkyl, alkylamino, thio, alkylthio, thioalkyl, carbamoyl, urea, thiourea, sulfonyl, sulfonate, sulfonamide, sulfonylamino, and sulfonyloxy.

9. The dispersible long-acting mold-proof urethane adduct or polyurethane resin according to claim 7, wherein the R11 of said structural formula is a hydrogen atom (—H), or an oxidized alkyl group, such as an oxidized methyl —OCH3, or an oxidized ethyl —OC2H5.

10. The dispersible long-acting mold-proof urethane adduct or polyurethane resin according to claim 4, wherein said NCO-containing isocyanate or said NCO-containing isocyanate polymer may be selected from the group consisting of aliphatic isocyanate, aromatic isocyanate, and polyisocyanate.

11. The dispersible long-acting mold-proof urethane adduct or polyurethane resin according to claim 4, wherein the structural formula of said amino group (NH)-containing mold-proof agent is 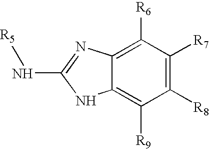
wherein each of the R5˜R9 of said structural formula is an atom or a functional group selected from the group consisting of hydrogen, alkyl, alkenyl, alkynyl, acyl, aryl, carboxylate, alkoxycarbonyl, aryloxycarbonyl, carboxamido, alkylamino, acylamino, alkoxyl, acyloxy, hydroxyalkyl, alkoxyalkyl, aminoalkyl, alkylamino, thio, alkylthio, thioalkyl, carbamoyl, urea, thiourea, sulfonyl, sulfonate, sulfonamide, sulfonylamino, and sulfonyloxy.
